(19) United States
(12) Patent Application Publication
(10) Pub. No.: US 2011/0282561 A1
(43) Pub. Date: Nov. 17, 2011

(54) CONTROLLER OF INTERNAL COMBUSTION ENGINE

(75) Inventors: Tateki Mitani, Tokyo (JP); Hideki Hagari, Tokyo (JP); Shingo Iwai, Tokyo (JP); Satoshi Nishikawa, Tokyo (JP)

(73) Assignee: MITSUBISHI ELECTRIC CORPORATION, Tokyo (JP)

(21) Appl. No.: 13/143,826

(22) PCT Filed: Mar. 4, 2009
(86) PCT No.: PCT/JP2009/054071

§ 371 Date: Jul. 8, 2011

(51) Int. Cl. F02D 41/00

(52) U.S. Cl. 701/102

(57) ABSTRACT

An ECU (13) includes: throttle-valve opening-degree control means (131) for controlling an intake airflow rate; target output-torque calculating means (132) for calculating a target output torque from an operating state of an engine (1) and an operation of an accelerator performed by a driver; target ignition-timing calculating means (133) for calculating target ignition timing based on the operating state of the engine (1); actual output-torque calculating means (134) for calculating an actual output torque of the engine (1) based on an engine rpm, a charging efficiency, the target ignition timing, an air-fuel ratio, and a total heating value of a fuel; and target intake-air quantity calculating means (135) for calculating a charging efficiency-to-torque conversion factor based on the charging efficiency and the actual output torque, and calculating a target charging efficiency based on the target output torque and the charging efficiency-to-torque conversion factor to calculate a target intake air quantity based on the target charging efficiency. Torque control for the engine is performed while the fuel properties are loaded as information, and hence an engine control amount for realizing the target output torque is realized with high accuracy.

### TECHNICAL FIELD

The present invention relates to a controller for an internal combustion engine, in particular, a controller for an internal combustion engine, which performs control on an output torque as a target to be controlled by using a total heating value of a fuel as one of controlling elements therefor.

### BACKGROUND ART

In recent years, there has been proposed control using an engine output shaft torque corresponding to a physical quantity which directly acts on control for a vehicle as a requested value of a driving force from a driver or each of vehicle systems (for automatic transmission control, brake control, traction control, and the like). Specifically, there has been proposed a technology for realizing cooperative control to obtain good running performance by determining an air quantity, a fuel quantity, and ignition timing, which correspond to control amounts for engine control, while using the engine output shaft torque as a target value of an engine output, estimating an actual output torque from an actual operating state of the engine, and then transmitting the actual output torque to each of the vehicle systems, specifically, so-called torque-based control. However, information of fuel properties is not provided, and therefore property values are fixed.

In the control described above, it is important to calculate the actual output torque of the engine with high accuracy to achieve the target output torque with high accuracy. In Patent Document 1, an engine torque T obtained at certain engine rpm (revolution per minute) and charging efficiency is estimated by approximating the engine torque as a quadratic function of ignition timing IG. More specifically, the engine torque is approximated by the following quadratic function having a peak at minimum advance for best torque (MBT) ignition timing,

T=−A·(IG−B)²+C (1)

where A, B, and C are preset as a map of the engine rpm and the charging efficiency. According to the operating state of the engine, A, B, and C are calculated from the map. Then, according to the above-mentioned Formula (1), the engine torque T is calculated. Then, a degree of opening of a throttle valve is subjected to feedback control so as to achieve the requested torque when the automatic transmission is changed. Then, a difference in torque is absorbed at the ignition timing to achieve the cooperative control.

Patent Document 2 describes a method for improving controllability for the output torque in response to a request by the driver without increasing the number of maps. More specifically, a loss torque and an ISC torque are added to a shaft torque requested by the driver, which is calculated from a degree of opening of an accelerator. After ignition timing efficiency correction and target A/F efficiency correction are performed, processing for converting the torque into the air quantity is performed. In Patent Document 2, a factor of a quadratic function in the ignition timing efficiency correction is calculated with a small number of maps.

Patent Document 1: JP 3225068 B

Patent Document 2: JP 2003-301766 A

### DISCLOSURE OF THE INVENTION

### Problem to be solved by the Invention

According to the methods described in Patent Documents 1 and 2, the fuel properties, which affect the torque, are constant. Actually, however, a total heating value greatly varies depending on the fuel properties. Therefore, with the methods described in Patent Documents 1 and 2, there is a problem in that an error occurs in the estimation of the engine torque. As a result, an engine control amount for realizing the target output torque cannot be realized with high accuracy.

The present invention has been made to solve the problem described above, and therefore has an object to provide a controller for an internal combustion engine, which obtains fuel properties, specifically, a total heating value of a fuel as information to perform torque control for the engine so as to realize an engine control amount for realizing a target output torque with high accuracy.

### Means for solving the Problem

The present invention provides a controller for an internal combustion engine, including: throttle-valve opening-degree control means for controlling a degree of opening of a throttle valve to control an intake airflow rate of the internal combustion engine; target output-torque calculating means for calculating a target output torque to be generated by the internal combustion engine from an operating state of the internal combustion engine and an operation of an accelerator performed by a driver; target ignition-timing calculating means for calculating target ignition timing based on the operating state of the internal combustion engine; actual output-torque calculating means for calculating an actual output torque of the internal combustion engine based on an engine rpm, a charging efficiency, the target ignition timing, an air-fuel ratio, and a total heating value of a fuel; and target intake-air quantity calculating means for calculating a charging efficiency-to-torque conversion factor based on the charging efficiency and the actual output torque, and calculating a target charging efficiency based on the target output torque and the charging efficiency-to-torque conversion factor to calculate a target intake air quantity to be sucked into the internal combustion engine based on the target charging efficiency, in which: the degree of opening of the throttle valve is controlled by the throttle-valve opening-degree control means so as to realize the target intake air quantity calculated by the target intake-air quantity calculating means.

### EFFECT OF THE INVENTION

The controller for an internal combustion engine, including: throttle-valve opening-degree control means for controlling a degree of opening of a throttle valve to control an intake airflow rate of the internal combustion engine; target output-torque calculating means for calculating a target output torque to be generated by the internal combustion engine from an operating state of the internal combustion engine and an operation of an accelerator performed by a driver; target ignition-timing calculating means for calculating target ignition timing based on the operating state of the internal combustion engine; actual output-torque calculating means for calculating an actual output torque of the internal combustion engine based on an engine rpm, a charging efficiency, the target ignition timing, an air-fuel ratio, and a total heating value of a fuel; and target intake-air quantity calculating means for calculating a charging efficiency-to-torque conversion factor based on the charging efficiency and the actual output torque, and calculating a target charging efficiency based on the target output torque and the charging efficiency-to-torque conversion factor to calculate a target intake air quantity to be sucked into the internal combustion engine based on the target charging efficiency, in which: the degree of opening of the throttle valve is controlled by the throttle-valve opening-degree control means so as to realize the target intake air quantity calculated by the target intake-air quantity calculating means. Therefore, the controller for an internal combustion engine obtains the fuel properties, specifically, the total heating value of the fuel as information to perform the torque control for the engine so as to be able to realize the engine control amount for realizing the target output torque with high accuracy.

### BRIEF DESCRIPTION OF THE DRAWINGS

FIG. 1 is a configuration diagram illustrating a configuration of an internal combustion engine according to Embodiment 1 of the present invention.

FIG. 2 is a block diagram illustrating a configuration of a controller for the internal combustion engine according to Embodiment 1 of the present invention.

FIG. 3 is a view showing data indicating fuel properties in the form of a table according to Embodiment 1 of the present invention.

FIG. 4 is a graph illustrating the relation between a refractive index and a total heating value per unit volume according to Embodiment 1 of the present invention.

FIG. 5 is a configuration diagram illustrating a configuration of a fuel-property sensor included in the controller for the internal combustion engine, according to Embodiment 1 of the present invention.

FIG. 6 is a graph illustrating a relation between the refractive index and an output voltage according to Embodiment 1 of the present invention.

### BEST MODE FOR CARRYING OUT THE INVENTION

### Embodiment 1

Hereinafter, an embodiment of the present invention is described in detail referring to the drawings.

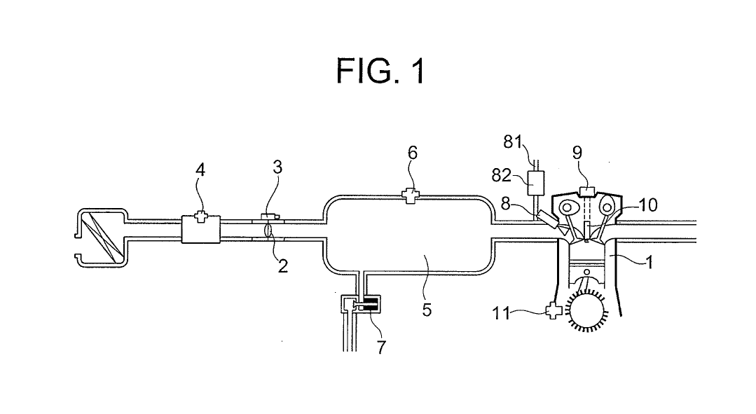

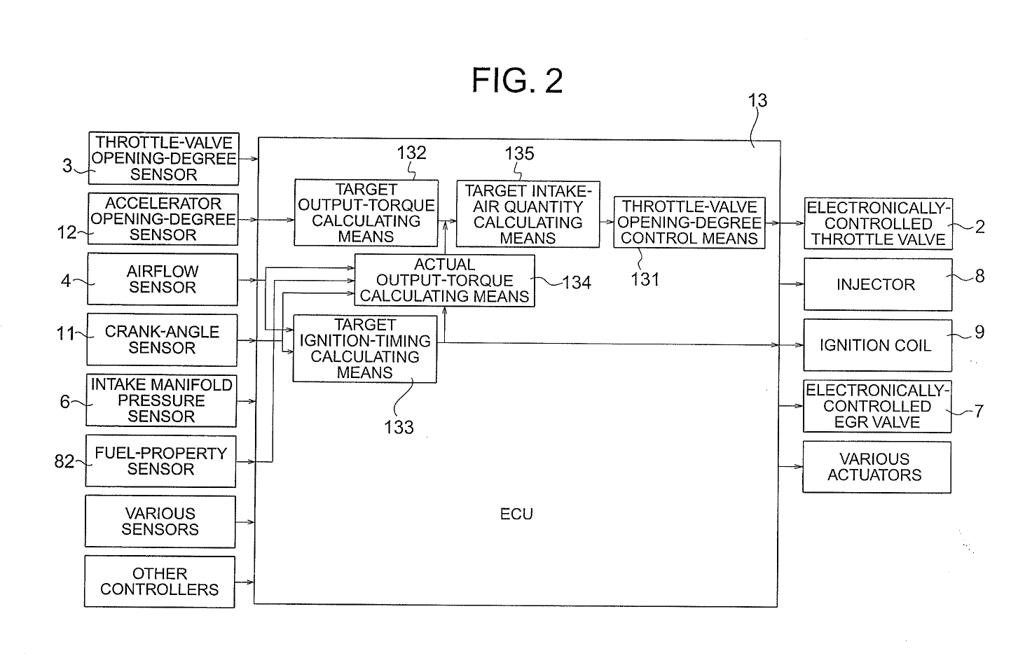

FIGS. 1 and 2 are configuration diagrams respectively and schematically illustrating an internal combustion engine and a controller for the internal combustion engine according to Embodiment 1 of the present invention.

As illustrated in FIG. 1, at upstream in an intake system of an internal combustion engine (hereinafter, referred to as “engine”) 1, an electronically-controlled throttle valve 2 which is electronically controlled so as to regulate an intake airflow rate is provided. Moreover, a throttle-valve opening-degree sensor is provided to measure a degree of opening of the electronically-controlled throttle valve 2. Further, at upstream of the electronically-controlled throttle valve 2 in the intake system, an airflow sensor 4 for measuring the intake airflow rate is provided.

At downstream of the electronically-controlled throttle valve 2 in the intake system, a surge tank 5 is provided. Further, an intake manifold pressure sensor 6 for measuring a pressure in the surge tank 5 is provided. Both or any one of the airflow sensor 4 and the intake manifold pressure sensor 6 may be provided. An electronically-controlled EGR valve 7 is connected to the surge tank 5.

In an intake passage at downstream of the surge tank 5, an injector 8 for injecting a fuel is provided. The injector 8 may be provided so as to be able to directly inject the fuel into a cylinder of the engine 1. Further, an ignition coil 9 and a spark plug 10 for igniting a mixture in the cylinder of the engine 1 are provided to the engine 1. A crank-angle sensor 11 for detecting an edge of a plate provided to a crankshaft so as to detect a rotation speed and a crank angle of the engine is provided to the engine 1. A pipe 81 for connecting a fuel pump (not shown) and the injector 8 to each other is provided. In the middle of the pipe 81, a fuel-property sensor 82 for measuring properties of the fuel is provided as close as possible to the injector 8.

As illustrated in FIG. 2, an electronic control unit (hereinafter, abbreviated as “ECU”) 13 is provided as a controller for the internal combustion engine. In FIG. 2, reference numeral 12 is an accelerator opening-degree sensor.

The intake airflow rate measured by the airflow sensor 4, the intake manifold pressure measured by the intake manifold pressure sensor 6, the degree of opening of the electronically-controlled throttle valve 2, which is measured by the throttle-valve opening-degree sensor 3, a pulse in synchronization with the edge of the plate provided to the crankshaft, which is output from the crank-angle sensor 11, and information of the fuel properties such as heavy or light, and an alcohol concentration of the fuel, which is output from the fuel-property sensor 82, are input to the ECU 13. In addition to the above-mentioned values, measurement values are also input from the accelerator opening-degree sensor 12 and other various sensors to the ECU 13. Further, a requested torque value from other controllers (for example, control systems for automatic transmission control, brake control, traction control and the like) is also input thereto.

Inside the ECU 13, throttle-valve opening-degree control means 131, target output-torque calculating means 132, target ignition-timing calculating means 133, actual output-torque calculating means 134, and target intake-air quantity calculating means 135 are provided.

A target intake air quantity output from the target intake-air quantity calculating means 135 is input to the throttle-valve opening-degree control means 131 so that the degree of opening of the electronically-controlled throttle valve 2 is controlled to achieve the target intake air quantity, thereby variably controlling the intake airflow rate of the internal combustion engine is performed.

A signal (data) indicating an operating state of the internal combustion engine and a value measured by the accelerator opening-degree sensor 12, which indicates an operation of the accelerator performed by the driver, are input to the target output-torque calculating means 132 so that a target output torque to be generated by the internal combustion engine is calculated from the above-mentioned values. The calculated target output torque is input to the target intake-air quantity calculating means 135.

Data indicating the operating state of the internal combustion engine such as an engine rpm detected by the crank sensor 11 and the intake airflow rate detected by the airflow sensor 4 is input to the target ignition-timing calculating means 133 so that the target ignition timing is calculated based on the input data. The calculated target ignition timing is input to the actual output-torque calculating means 134 and the ignition coil 9. As a result, the energization of the ignition coil 9 is controlled so that the target ignition timing is achieved.

The engine rpm output from the crank-angle sensor 11, the charging efficiency output from the airflow sensor 4, the target ignition timing output from the target ignition-timing calculating means 133, an air-fuel ratio, and the total heating value of the fuel, which is output from the fuel-property sensor 82, are input to the actual output-torque calculating means 134 so that an actual output torque of the internal combustion engine is calculated based on the input values. A method of computing the actual output torque is described below. The calculated actual output torque is input to the target intake-air quantity calculating means 135. The air-fuel ratio is detected by an O₂ sensor (not shown) mounted to an exhaust manifold of the engine 1.

The charging efficiency output from the airflow sensor 4 and the actual output torque output from the actual output-torque calculating means 134 are input to the target intake-air quantity calculating means 135 so that a charging efficiency-to-torque conversion factor is calculated from the input values. The target output torque output from the target output-torque calculating means 132 is further input to the target intake-air quantity calculating means 135 so that a target charging efficiency is calculated based on the target output torque and the calculated charging efficiency-to-torque conversion factor. Then, the target intake air quantity to be sucked into the internal combustion engine is calculated based on the target charging efficiency. The calculated target intake air quantity is input to the throttle-valve opening-degree control means 131.

The ECU 13 has the configuration as described above and controls the degree of opening of the throttle valve 2 by the throttle-valve opening-degree control means 131 so as to realize the target intake air quantity calculated by the target intake-air quantity calculating means 135. Specifically, in the ECU 13, the actual torque is calculated from the input various data. The target torque is set based on the degree of opening of the accelerator, the operating state of the engine, and the requested torque value from the other controllers. The target intake airflow rate and the target ignition timing are calculated so as to achieve the set target torque. The electronically-controlled throttle valve 2 is controlled so as to achieve the target intake airflow rate, whereas the ignition coil 9 is energized so as to achieve the target ignition timing. The degree of opening of the electronically-controlled EGR valve 7 is controlled according to the operating state, and the injector 8 is driven so as to achieve the target air-fuel ratio. Further, command values to various actuators other than those described above are also calculated.

Next, the method of computing the actual output torque in the actual output-torque calculating means 134 is described. Specifically, C in Formula (I) described above is corrected according to the fuel properties. Here, Ain Formula (I) is a factor indicating a degree of reduction in torque when the ignition timing is away from the MBT, B is MBT ignition timing, and C is the output torque at the MBT. As each of A and B, the same value is used for an alcohol-blended fuel and gasoline because A and B do not greatly differ even if any of the alcohol-blended fuel and gasoline is used. Moreover, C is expressed by the following Formula.

C=(thermal efficiency at MBT)×(intake air quantity)×(inverse of air-fuel ratio (fuel-air ratio))×(total heating value of fuel)

Here, the total heating value of the fuel can be calculated by a method described below.

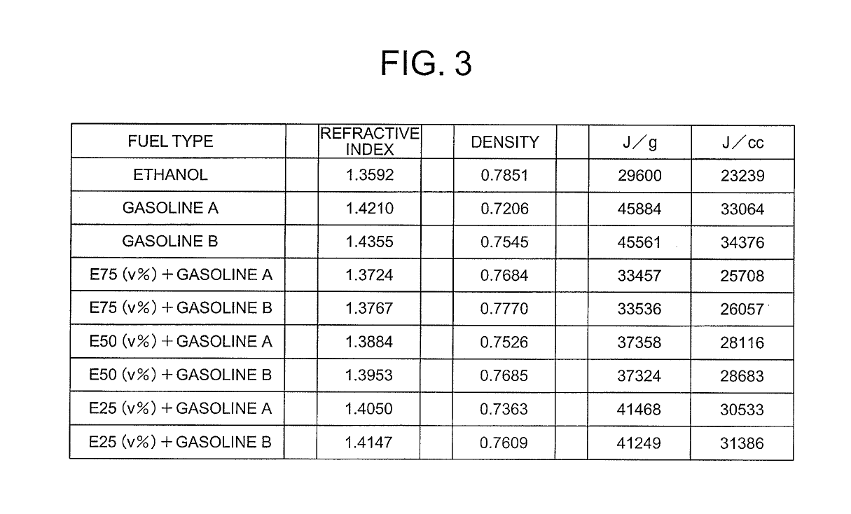

FIG. 3 shows values obtained by actually measuring the relation between a total heating value per unit weight (g) and a refractive index for various blended fuels containing a base fuel and alcohol. In FIG. 3, for the various blended fuels, the refractive index, a density, and the total heating value (J/g) per unit weight are actually measured values. A total heating value (J/cc) per unit volume is a calculated value obtained by multiplying the total heating value (J/g) per unit weight by the density.

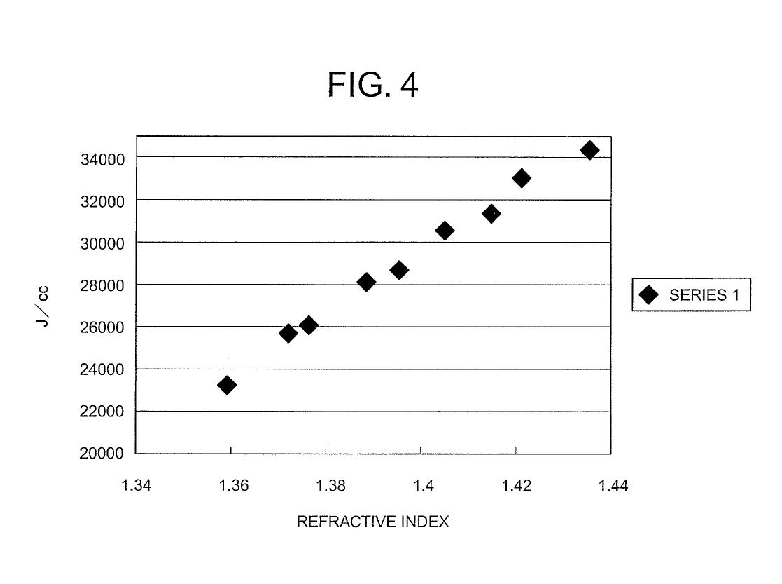

FIG. 4 is obtained by plotting the relation between the refractive index and the total heating value (J/cc) per unit volume for each of the blended fuels illustrated in FIG. 3. The horizontal axis of the graph of FIG. 4 represents the refractive index, whereas the vertical axis represents the total heating value (J/cc) per unit volume. As is apparent from FIG. 4, the total heating value (J/cc) per unit volume with respect to the refractive index is approximately on a straight line. This fact shows that the refractive index of the fuel has a proportional relation with each of the density of the base fuel and an alcohol concentration, and therefore an estimate value of the total heating value (J/cc) per unit volume can be calculated from a measured value of the refractive index of the fuel for various blended fuels having different base fuel densities and alcohol concentrations.

The signal from the fuel-property sensor 82 may be constantly read. Alternatively, the signal may be read under the condition where, for example, the engine is started, a signal is output from a sensor (not shown) for detecting fuel feeding, or a value of a fuel-level sensor (not shown) abruptly changes.

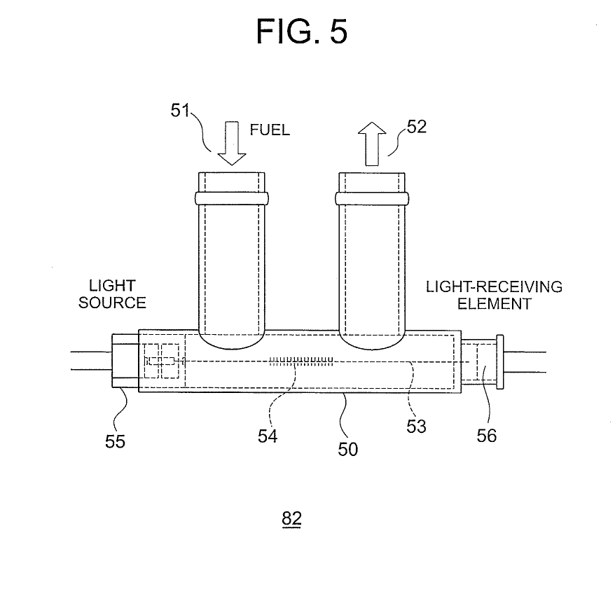

FIG. 5 is a diagram illustrating an example of a configuration of the fuel-property sensor 82 illustrated in FIGS. 1 and 2. In FIG. 5, reference numeral 50 is a tube, 51 is a fuel inlet provided on a side surface of the tube 50, 52 is a fuel outlet provided similarly on the side surface of the tube 50, 53 is an optical fiber provided in the tube 50, 54 is a fiber grating provided on the optical fiber 50, 55 is a light source provided at one end of the tube 50, and 56 is a light-receiving element provided at the other end of the tube 50. The light source 55 includes, for example, an LED.

In the fuel-property sensor 82, when the fuel flows from the inlet 51 to the outlet 52, the fuel comes into contact with the optical fiber 53 stretched in the tube 50. The optical fiber 53 is constituted of a core in the center and a cladding in a circumferential portion. The fiber grating 54 is formed on the core of the optical fiber 53. Light emitted from the light source 55 toward the optical fiber 53 is incident on the optical fiber 53 to be then transmitted through the fiber grating 54. A total light intensity of the light transmitted through the fiber grating 54 changes depending on the property (refractive index) of the fuel held in contact with the outer side of the cladding of the optical fiber 53. Therefore, the property (refractive index) of the fuel can be detected from the amount of light received by the light-receiving element 56. The fuel-property sensor 82 converts the amount of received light detected by the light-receiving element 56 into a voltage and then outputs the obtained voltage.

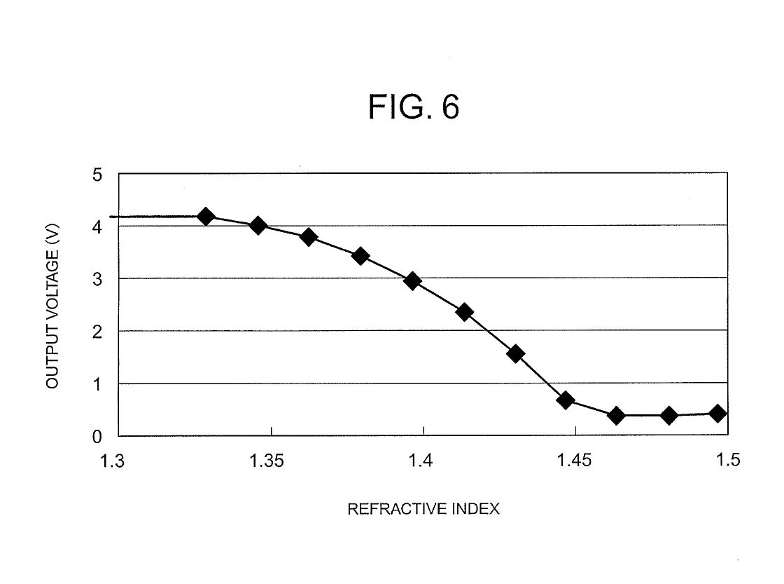

FIG. 6 is a graph showing the relation between the property (refractive index) of the fuel and the output voltage (V) from the fuel-property sensor 82. In FIG. 6, the horizontal axis represents the property (refractive index) of the fuel, whereas the vertical axis represents the output voltage (V) from the fuel-property sensor 82. From the graph of FIG. 6, it is understood that the output voltage (V) from the fuel-property sensor 82 has an approximately proportional relation with the refractive index. Therefore, the estimate value of the refractive index can be calculated form the value of the output voltage (V) from the fuel-property sensor 82.

As described above, according to the present invention, the torque control for the engine is performed while the total heating value of the fuel, which greatly changes depending on the fuel properties, is being loaded as information, as described in Embodiment 1. As a result, even if the fuel properties change during running, at the time of fueling, or after long-term storage, the engine torque can be estimated with high accuracy by correcting the total heating value of the fuel in Formula (I) for obtaining the engine torque T based on the fuel properties. As a result, excellent effects of realizing the target torque to perform the torque control for the engine with high accuracy can be obtained.

1. A controller for an internal combustion engine, comprising:
throttle-valve opening-degree control means for controlling a degree of opening of a throttle valve to control an intake airflow rate of the internal combustion engine;
target output-torque calculating means for calculating a target output torque to be generated by the internal combustion engine from an operating state of the internal combustion engine and an operation of an accelerator performed by a driver;
target ignition-timing calculating means for calculating target ignition timing based on the operating state of the internal combustion engine;
actual output-torque calculating means for calculating an actual output torque of the internal combustion engine based on an engine rpm, a charging efficiency, the target ignition timing, an air-fuel ratio, and a total heating value of a fuel; and
target intake-air quantity calculating means for calculating a charging efficiency-to-torque conversion factor based on the charging efficiency and the actual output torque, and calculating a target charging efficiency based on the target output torque and the charging efficiency-to-torque conversion factor to calculate a target intake air quantity to be sucked into the internal combustion engine based on the target charging efficiency,
wherein the degree of opening of the throttle valve is controlled by the throttle-valve opening-degree control means so as to realize the target intake air quantity calculated by the target intake-air quantity calculating means, and
wherein the total heating value of the fuel is estimated from a measured value of a refractive index of the fuel.

2. (canceled)

3. A controller for an internal combustion engine according to claim 1, wherein the fuel contains alcohol.

4. A controller for an internal combustion engine according to claim 3, wherein the alcohol comprises ethanol, and an amount of the alcohol contained in the fuel ranges from 0 to 100% in volume ratio.

5. A controller for an internal combustion engine according to claim 3, wherein:
the refractive index of the fuel has a proportional relation with each of a density of a base fuel contained in the fuel and an alcohol concentration; and
the total heating value of the fuel is estimated from a measured value of the refractive index of the fuel for fuels having a different density of the base fuel and a different alcohol concentration from each other.

6. A controller for an internal combustion engine according to claim 1, wherein:
the refractive index of the fuel is measured by a fuel-property sensor; and
the fuel-property sensor comprises:
an optical fiber including a core provided with a grating and a cladding;
a light source for emitting light to the optical fiber; and
a light-receiving element for detecting a total light intensity of the light emitted from the light source, the light being incident on the optical fiber to be transmitted through the grating.
